(19) United States
(12) Patent Application Publication
(10) Pub. No.: US 2005/0110270 A1
(43) Pub. Date: May 26, 2005

(54) Piping connector

(76) Inventor: I-Jen Huang, Taichung (TW)

Correspondence Address: I-Jen Huang, PO Box 82-144, Taipei, TW

(21) Appl. No.: 10/716,542

(22) Filed: Nov. 20, 2003

(51) Int. Cl. F16L 21/00

(52) U.S. Cl. 285/31

(57) ABSTRACT

A piping connector is disclosed. The connector comprises pipes and connection body, and ejector for ejecting water, characterized in that the two ends of the connection body are provided with threaded face for locking with an arch shaped threaded cap passed through the pipes for connection, the rim face at the connection end of the pipe is provided with a positioning hole for the insertion of a positioning rim for engagement with the threaded cap, together with the mounting of a sealing rim and a pad, the connection of the piping connector is secured.

### BACKGROUND OF THE INVENTION

(a) Technical Field of the Invention

The present invention relates to connector, and in particular, piping connector employing a positioning rim to be mounted to a positioning hole at the rim face of the connecting end.

(b) Description of the Prior Art

For piping or water tube connection, a worker has to first measure the location for installing pipes accurately. The pipes are then connected to each other by using connectors. As shown in FIGS. 5 to 7, there is shown a conventional connection module for piping, wherein two pipes 30 are provided with a threaded face 31 and a connection body 32 is locked to the face 31. The connection body 32 is provided with a screw hole 33 at the center thereof for locking to an ejector 34 to discharge water. In connection, the two pipes 30 are connected to the threaded face 31 of the connection body 32 at two ends. To avoid leakage, a sealing tape is generally applied to the threaded face 31. The disadvantage of such piping system and connection is that the end of the pipe has to be provided with a threaded face 31, which has to be completed by a lathe machine.

The making of the threaded face 31 cannot be done at the worksite. Another advantage is that the position of the ejector 34 cannot be easily controlled to the exact locking position. In view of the above, the connection is complicated and not convenient.

### SUMMARY OF THE INVENTION

Accordingly, it is an object of the present invention to provide a piping connector comprising pipes and connection body, and ejector for ejecting water, characterized in that the two ends of the connection body are provided with threaded face for locking with an arch shaped threaded cap passed through the pipes for connection, the rim face at the connection end of the pipe is provided with a positioning hole for the insertion of a positioning rim for engagement with the threaded cap, together with the mounting of a sealing rim and a pad, the connection of the piping connector is secured.

Yet another object of the present invention is to provide a piping connector, wherein the installation of the connector is simple and the direction of water flow can be easily controlled.

Still another object of the present invention is to provide a piping connector, wherein the worker can cut the required length of the pipe at the worksite and connection can be done at the exact location of the worksite.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the piping connector of the present invention.

FIG. 2 is a perspective view of the piping connector of the present invention.

FIG. 3 is a sectional view of the piping connector of the present invention.

FIG. 4 is a schematic view showing the ejector in accordance with the present invention.

FIG. 5 is a perspective exploded view of a conventional connector for piping.

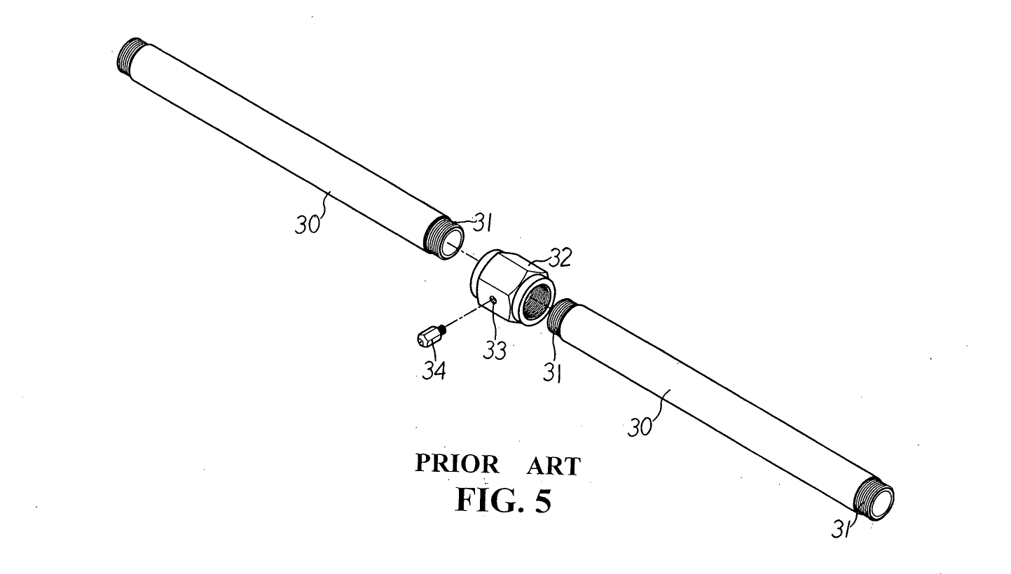

FIG. 6 is a perspective view of a conventional connector for piping.

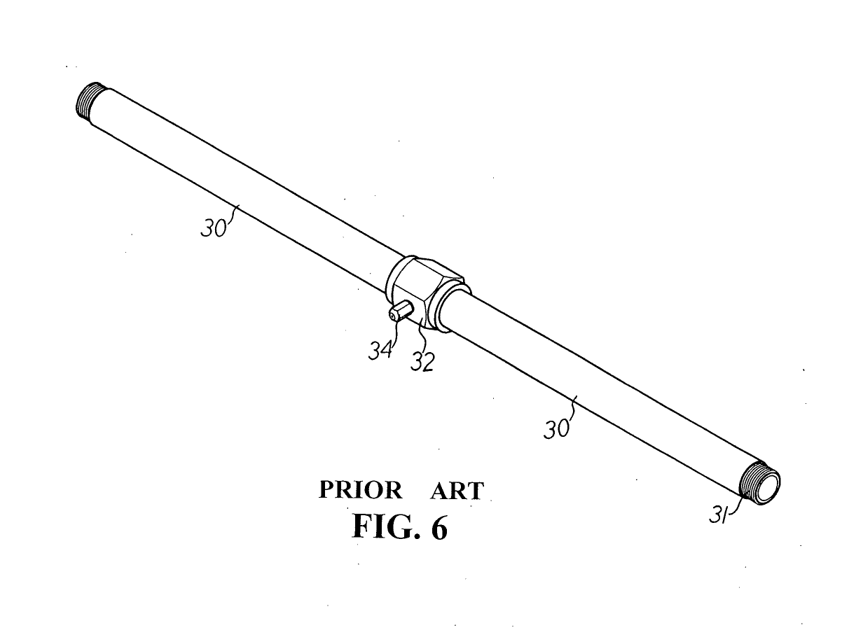

FIG. 7 is a schematic view of the connector for piping.

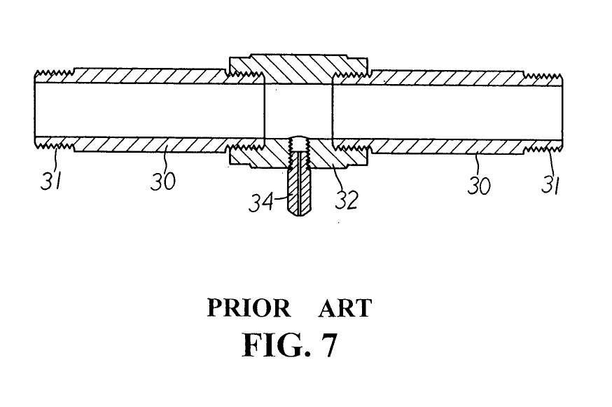

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

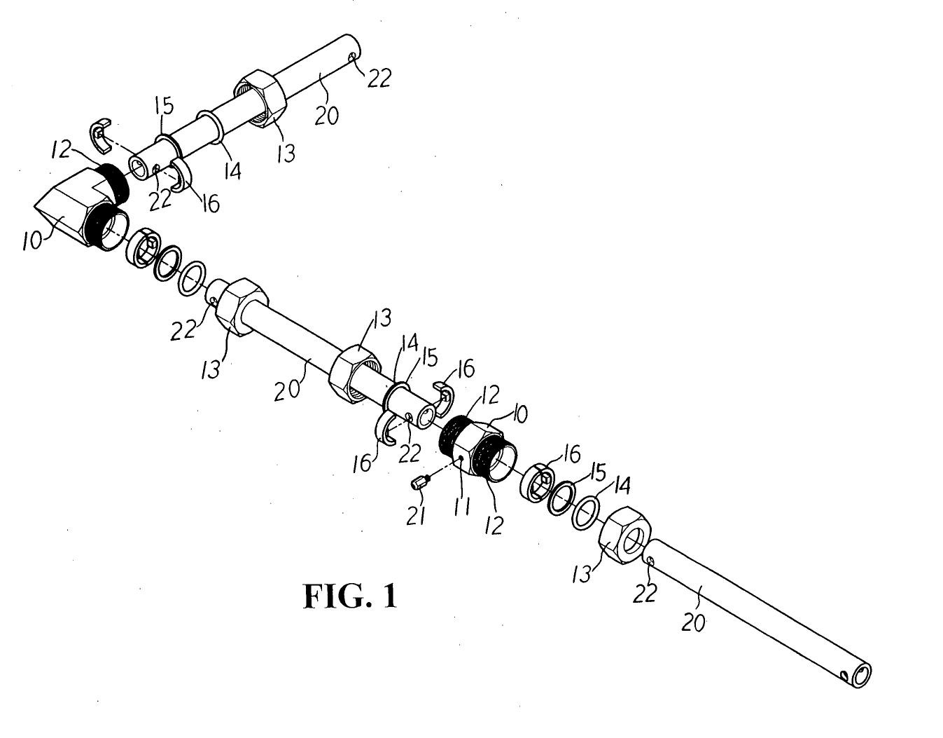

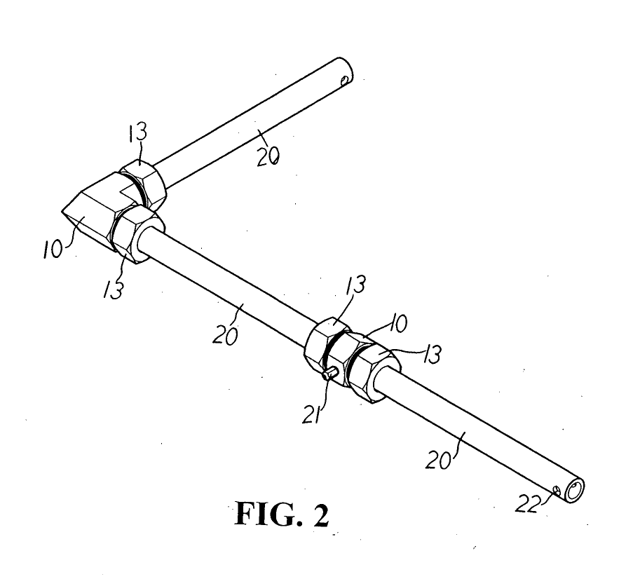

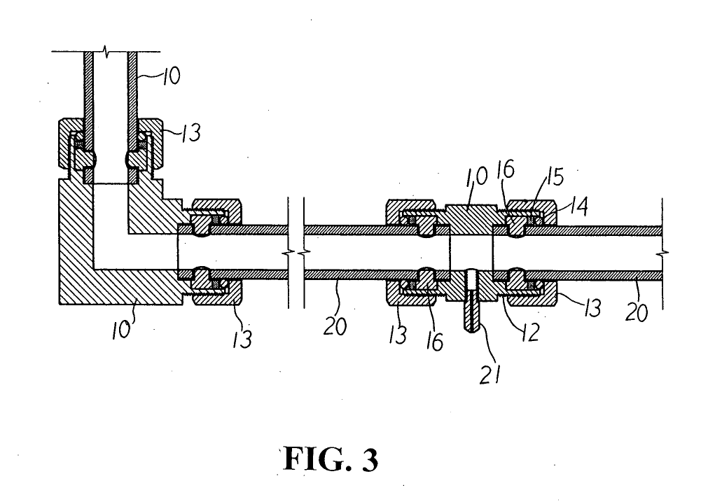

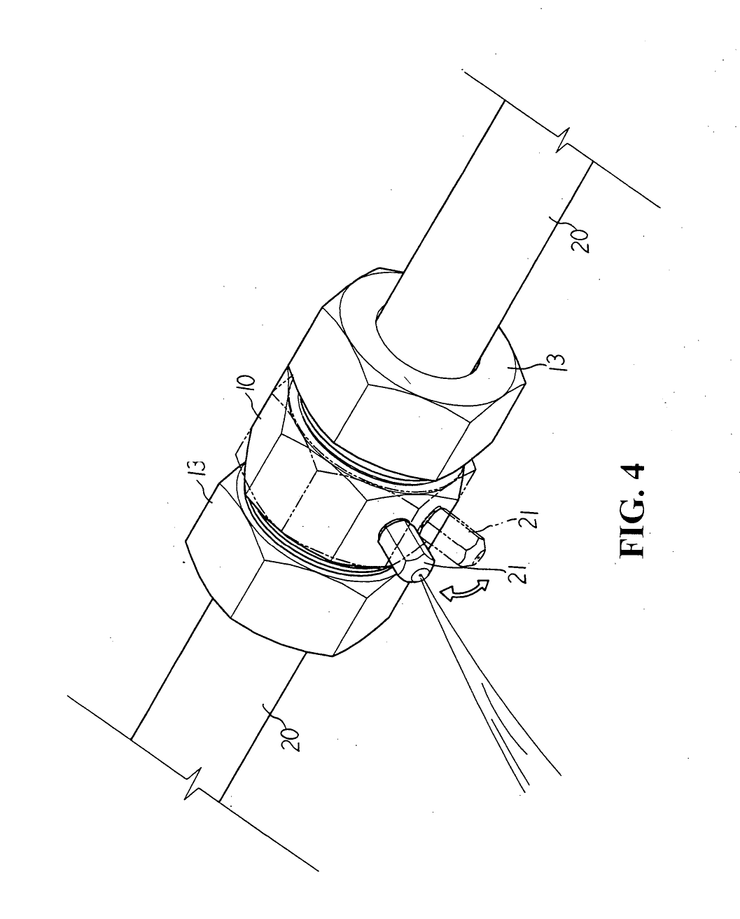

Referring to FIGS. 1 to 4, there is shown a piping connector for a pipe 20 at a connection body 10. The middle section of the connection body 10 is made into clipping face for locking. Generally, it is a hexagonal shape having a through screw hole 11 for locking with an ejector 21 to form a hole for ejection. The two ends of the connector body are provided with a threaded face 12 for locking with a cap 13 having an arch shape. The interior of the cap 13 is mounted with a sealing rim 14, a pad 15 and a positioning rim 16. The number of rims 16 can be more than one. The rim face of the pipe, close to the connection end of the pipe 20 is provided with a through hole 22. The hole 22 can be more than one based on various diameter and the holes can be drilled at equal distance or symmetrically for the engagement of the rim 16.

In connection, the cap 13 is first inserted into the end head of the pipe 20 and is then inserted in sequence with the sealing rim 14, the pad 15 and the rim 16. The cap 13 mounts to the connection body 10 at one end and the two pipes 20 are connected. The packing of the sealing rim 14, the pad 15 will seal the possible water leakage. The through hole 11 locked with the ejector can be adjusted to provide a required water spraying pattern, such as atomized water spray or sprinkling water pattern. The ejector enables the increase of pressure on the water flow.

Other advantages of the present invention are the fittings for the connector body 10 can be made into a uniform specification, and this will facilitate production and the cost of production is reduced. Further, the through holes 22 at the rim face of the connection end of the pipe 20 can be drilled easily, which facilitates the mounting of the positioning rim 16.

Further, the mounting of the ejector 21 is flexible on the connector in accordance with the present invention, that is, the height of the ejector 21 can be easily adjusted and controlled by the connector body 10.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A piping connector comprising pipes and connection body, and ejector for ejecting water, characterized in that the two ends of the connection body are provided with threaded face for locking with an arch shaped threaded cap passed through the pipes for connection, the rim face at the connection end of the pipe is provided with a positioning hole for the insertion of a positioning rim for engagement with the threaded cap, together with the mounting of a sealing rim and a pad, the connection of the piping connector is secured.

2. The piping connector of claim 1, wherein the side face of the middle section of the connection body is provided with through screw hole for locking with an ejector so that the connection head is freely rotated and controlled.

3. The piping connector of claim 1, wherein the number of the through holes on the end face of the pipe is varied in accordance with the diameter of the pipe.
